(19) United States
(12) Patent Application Publication
(10) Pub. No.: US 2006/0156315 A1
(43) Pub. Date: Jul. 13, 2006

(54) Method, computer-readable medium and apparatus for providing a graphical user interface in a client-server environment

(76) Inventors: Larry James Wood, Penn Valley, CA (US); Jonathan D. Richards, Meadow Vista, CA (US); Eric Dean Katz, Grass Valley, CA (US); Adam J. Rieger, Nevada City, CA (US)

Correspondence Address: SIERRA PATENT GROUP, LTD., 1657 Hwy 395, Suite 202, Minden, NV, 89423, US

(21) Appl. No.: 10/826,673

(22) Filed: Apr. 16, 2004

Related U.S. Application Data
(60) Provisional application No. 60/473,751, filed on May 27, 2003.

(51) Int. Cl. G06F 9/46

(52) U.S. Cl. 719/328

(57) ABSTRACT

A client program in a client/server relationship receives commands creating a specific implementation of graphical user interface (GUI) components and receives any data to be displayed in the interface components from the server program. As the end user interacts with the client, the client returns events and data to the server for processing. The commands and events constitute a protocol, published via an API. The transmission of commands events between the client and server is accomplished without linking the programs. The specific GUI implementation is specified by the server application and revealed to the client only at run time.

### RELATED APPLICATION

This application claims priority to provisional patent application Ser. No. 60/473,751, filed Apr. 19, 2003, on behalf of inventor Larry Wood, incorporated by reference herein in its entirety.

### FIELD OF THE INVENTION

This invention relates generally to modern personal computer systems that possess a graphic interface and API for program development, and associated electronic devices including personal digital assistants (PDAs), cell phones and other consumer devices that also have integrated operating systems as a component of the product, and more specifically relates to data processing in computer systems utilizing a graphical user interface (GUI).

### BACKGROUND OF THE INVENTION

The first personal computers supported a text interface as used on the mainframe (IBM, DEC) terminal interface—usually a matrix of 24 columns and 40 or 80 rows, In 1981, Xerox introduced a computer with a mouse pointing device, a bit-mapped screen, featuring a graphic window system: distinctive rectangles on the monitor with visible boundaries and a title. These windows possessed features including movability, resizing, scrolling of data, and window closing mechanisms. These windows contained the data being manipulated, and supported multiple fonts. In addition, the interface featured the now familiar menus, iconic representation of both physical and electronic objects (disk drives, printers, applications and data files, and dialog boxes). Macintosh, Windows, and now Linux and Unix operating systems all provide a Graphical User Interface (GUI) or window interface. Its value to commerce is hard to over estimate; virtually every personal productivity program in the world is now written to exploit the virtues and strengths of the permissive, flexible and comprehensive windowing interface.

Software developers designing client/server-based networked multi-user applications for the purpose of adding, editing and deleting records in enterprise software systems desire to incorporate personal computers to implement a custom GUI for their end users. Several technologies and development approaches are available, and have varying benefits, usually a trade off between development costs and deployment costs vs. effectiveness, performance, and maintainability.

The result may meet the usability expectation of the end users, but its functionality is unique to the server to which it is paired, and most of the code is not generally reusable, and development costs are usually highest of the methods. In addition, each custom application must be installed on every end user's personal computer, and maintained in parallel with its partner server application. This solution is custom, so a custom API must be developed to transfer data between the client and server, plus network communications functionality.

Screen scraping is a method employed on existing server applications originally designed with a terminal interface. The term, “terminal interface” generally describes a closely-related group of text and number only interfaces whereby the text and numbers are typically organized in rows of columns. The typical terminal interface allows the user to enter data in data entry fields, providing read-only labels for each field, and allows the user to use a tab key, enter key, and function keys to control the interface. In common vernacular, the terminal interface is often called a “green screen” because of the monochromatic phosphor-green on black vacuum terminals employed. The client application receives the terminal data in real time. Each screen of a terminal interface is processed, rendering a windowing version in a customized window. When the user is done with the data, it is converted back to the terminal interface for backward compatibility, written into the terminal buffer and returned to the enterprise application. When screen scraping is employed, the enterprise application is left unaltered (termed non-invasive).

This process of converting the data in real time to a GUI window is CPU intensive, thus reducing the responsiveness of the overall system. Additionally, the most significant benefits of a modern GUI are not realized. Typical design methods of mainframe programs are narrow functionality, exposed by narrow and deep layers of functions that require the user to manually back out program control. Compared to modern permissive interfaces that are wide and shallow (typified by a wide array of menus, each with many commands), this style of programming is antiquated and difficult to use. IBM has developed a technique for performing screen scraping at design time rather than run time. The benefit is better performance over the original, but the results are in Java, so some of that is lost to Java performance problems.

The biggest drawback to screen scraping is the inability to exploit the major virtues of the modern GUI. The result is a direct correlation of green screens now recreated in dialog boxes, and not much more. Most of the value of the modern interface is lost in the exercise. The application, presumed to be a pre-existing application, has a terminal interface.

To attempt to reduce design costs over other methods, developers have produced web-based server applications with HTML documents as the GUI. If the modification is to be non-invasive, screen scraping is employed to produce HTML-based screens. If it is determined that the application may be modified, HTML may be directly placed in the application as a replacement for the original terminal interface. Complexities include the introduction of the Web-server platform itself, reducing network efficiency and increasing response time.

Web servers have been heavily employed to ‘publish’ or make network-ready enterprise applications because HTTP possesses many characteristics that mimic the more complex server-based operating systems with less cost and complexity. However, the use (or non-use) of Web servers (http) does NOT force the use of HTML as a user interface technology, though that is almost the exclusive choice of developers.

HTML is the underlying page layout protocol of Web pages. It possesses only limited interactive elements—fields and clickable links are the only interactive aspects of the disclosure. Links can be viewed as virtually useless most enterprise applications including transaction processing systems, because functionality is highly organized and controlled by business logic; where as clickable links are most effective for random navigation; leaving fields as the lone interactive component of modest value. Developers use bitmaps and regions to simulate menus; other interaction is implemented through JavaScript. The result is a clumsy, unwieldy and fragile technical implementation.

Web applications also are poor performing relative to other solutions because most Web pages are usually at least 10,000 to 50,000 bytes or more in size. In most cases, over two thirds of the data is dedicated to the interface itself—not the business data the user is actually utilizing. Surprisingly, development costs are often higher than other GUI development methods. Rentals.com, a dotcom firm, spent approximately $10,000 in engineering costs per Web page to produce their web-based rental property management system.

The page metaphor is effective for displaying text and graphics in book format. It is not an effective metaphor for business applications. Windowing interfaces use windows, not pages, as a basic data presentation metaphor. HTML is a crude page layout system that works reasonably well for static, text and picture-based Web pages with little or no user interaction. HTML is a dismal failure for producing consistent, stable, permissive and flexible application interfaces for business applications that focus primarily on record viewing, creation, editing, searching and browsing, deleting, filing and printing. The result is that Web-based enterprise applications are usually disappointing. HTML was not designed for interactivity, nor productivity. Web pages are usually designed for the computer novice rather than the experienced user. This development mentality is opposite of GUI-based personal productivity tools, which are designed for the efficient, experienced user. Training and learning are considered external responsibilities of the end user. In addition, the HTML page lends itself well to informing, entertaining and influencing users but was never intended as a vehicle for highly-productive, efficient and powerful enterprise applications.

Java Virtual Machine is a relatively new architecture that launches small applets written in JavaScript from servers to be run on the local device (personal or network computer). Java delivers a graphic user interface similar to (but not as robust) as the native interface found on the supporting platform. For example, a Java interface is not a Windows interface, nor is it a Macintosh interface. Consequently, users will encounter differences in behavior and performance, factors that reduce productivity and satisfaction. Additionally, Java is a very complex language. Consequently, development costs are high because one must use Java programmers for the client application development, and the resulting product runs only in a Java Virtual Machine, slowing down the user's use of the application. Additionally, the result is a custom, client-server application with the associated problems of fragility, lack of reusability, two-program maintenance costs, etc. Its key value is cross-platform functionality.

X-Windows is an early GUI implementation, used mainly in UNIX environments for applications written in C, to remotely display graphical screen information from central servers, where it was originally rendered as bitmap data. X-Windows is a complex and expensive development methodology, with expensive terminals and high bandwidth requirements due to bitmap data transfer to instantiate the GUI, and intense, fine-grained interaction between server and client.

The business advantage of quickly and economically migrating to server-based enterprise applications with native GUIs is a foregone conclusion, eliminating the need to maintain (or develop new) applications using screen interfaces. Screen interfaces are a shocking transition to personal computer users who intimately know how to use a modern window interface, utilized on each of their personal productivity applications.

Thus, there is a heartfelt need to move from a personal productivity application to an enterprise productivity application and enjoy the benefits of modern graphic user interface technology.

### SUMMARY OF THE INVENTION

A client application program in a client/server relationship receives commands creating a specific implementation of graphical user interface (GUI) components and transmits data and/or data structures to be displayed in the interface components, under server program control. The sending of these functions as commands, and the receipt of functions known as events may be accomplished without linking the programs. The specific GUI implementation is specified by the server application designer and revealed to the client only at run time.

The client application returns events to the server application as a semaphore mechanism to alert the server application of material changes in the state of the client application. Examples include end-user selection (usually by clicking or pressing key combinations as an alternative to a mouse click) of interface elements including menu items, icons, popup menus, radio, dialog and check box buttons, close boxes, cancel, apply and OK buttons, text fields, grid cells, etc. The user may also select and operate on the data that has been created or changed in these components by the usual methods of selecting text, clicking on graphics to select or register an x-y coordinate, or clicking iconic representations of data, for example. These events are processed in the server application's business logic by callback routines specified in the API.

Together, the server and client applications function as one unit much like a modern automobile radio possessing a back plane and a face plate. The server application controls data access and storage functionality, executing application logic to implement the specific functionality of the server application, and controls the GUI remotely by means of commands executed by the client application, and events, executed by the server application.

In one aspect, the present invention provides a method of providing a graphical user interface (GUI) to an end-user, the method comprising a client application receiving commands from a server application, the commands dictating a GUI implementation to be displayed to an end-user, the GUI implementation revealed to the client application only at run time; and the client application returning events to the server application, the events indicating state change in the client application.

In another aspect, the present invention provides a computer-readable medium containing instructions which, when executed by a computer, provide a graphical user interface (GUI) to an end-user, by directing a client application to receive commands from a server application, the commands dictating a GUI implementation to be displayed to an end-user, the GUI implementation revealed to the client application only at run time; and directing the client application to return events to the server application, the events indicating state change in the client application.

In yet another aspect, the present invention provides A client application for use in a client-server environment, the client application comprising means for receiving commands from a server application, the commands dictating a GUI implementation to be displayed to an end-user, the GUI implementation revealed to the client application only at run time; and means for returning events to the server application, the events indicating state change in the client application.

Other features and advantages of the present invention will become apparent upon reading the following detailed description, when considered in conjunction with the accompanying figures, in which:

### BRIEF DESCRIPTION OF THE DRAWINGS

FIG. 1 illustrates command and event sequence in a session;

FIG. 2 illustrates client and server applications by major functional component;

FIG. 3 illustrates typical client user interface design and interaction;

FIG. 4 illustrates server applications and client application operation on a client via a communication link;

FIG. 5 illustrates a GUI client application main logic diagram;

FIG. 6 illustrates a AGIL command processing logic diagram;

FIG. 7 illustrates an exemplary Command Group logic diagram; and

FIG. 8 illustrates an AGIL Event processing logic diagram.

### DETAILED DESCRIPTION

The present invention provides a client application that provides the end user with a specific GUI as directed by the server application at run time, by means of a series of specialized remote procedure calls to the client application in which commands are sent to the client application to dictate the GUI to be displayed. Events returned from the client application to the server application to indicate changes in the state of the GUI and data exchanged in the process.

In an embodiment, the client application allows the end user to connect and log on to the server application by selecting from a displayed dialog a list of previously-identified server applications with logon details, for example, a common name of the application for user identification, the name and path or location of the application on the server platform, the user identity and password (which are optional, and dependent on the specific server programs privacy and authentication requirements), and the transport over which to connect, or allows creation a new transport for selection. Additional, secondary functionality allows the user to manage this server application list (select, create, edit or delete).

The client application of the present invention can be implemented in Windows, and a wide variety of computer operating systems that have a GUI or windowing application interface, by porting the code and adapting it to the new platform. Practical operating system environments include PalmOS, PocketPC, WinCE, Linux and Unix.

The client application of the present invention is similar to a Web browser, in the sense that it does not provide specific application functionality in and of itself. A Web browser performs no useful function until connected to a Web server; the client application of the present invention is not designed with and does not present an application-specific GUI in the absence of server application control. The client application of the present invention possesses a minimal set of interface elements to allow the user to log on and off of the intended server.

The client application of the present invention is designed to provide a rich and productive GUI for multi-user enterprise applications. The client application is based on a protocol described herein that eliminates the requirement for HTML as a method of presenting a GUI and/or data. This elimination of the requirement for using HTML to create and present the GUI with the data significantly reduces the cost of developing and delivering business software, while dramatically improving the quality of client/server and web-based enterprise applications.

The specific GUI presented by the client application of the present invention is specified at run time, not design time, and is controlled by commands sent from the server that reference resources such as menus, toolbars, and windows, and the client application in return communicates to the server application via events to notify the server of significant state changes. The Abstract Graphical Interface Language (AGIL) command and event protocol described herein provides a series of functions that control a GUI on a wide variety of computing devices.

In an embodiment, AGIL protocol (s) may be wrapped in <HTML> and </HTML> elements to create an HTML document for compliant transfer to and from HTTP servers including Apache, WebSphere by IBM, and IIS by Microsoft, if such servers require a properly formed HTML file. The utilization of an HTTP (Web) server is dependent on the server programmer's requirements and is not a required component of the present invention, which operates in various embodiments over other communication circuits such as TCP/IP via Ethernet, PPP over dialup circuits, serial, WiFi, Bluetooth, and the like.

In accordance with the present invention, functions (referred to herein as commands) are transmitted from the server application to the client application for execution. Function execution calls (referred to herein as events) from the client application are received by the server application without actually binding the two applications together via linking greatly enhances flexibility by employing only a communications session between the client and the server application.

AGIL commands and events are exposed in the API used in the server application to control the GUI of the client application and perform user-selected tasks via events that are returned from the client application. The AGIL protocol of the present invention provides a high-level abstraction of the very detailed and complex windowing interface on modern personal computers. The AGIL protocol condenses many API calls into one, reducing the number of calls to well under 200, while retaining the functionality most needed by enterprise applications. Commands are used to create menu bars, display dialog boxes and transmit data for display in windows. Events received from the client application are used to determine what the user wants done. For example, menu events are received by the server application when the user has chosen a particular menu item, such as Close or Find. Events are received by the server application to instruct the server application to save an edited record, or indicate when the user has moved a window or closed it. Received events also can instruct the server application to send more records when the user has scrolled to the bottom of a populated table.

In an embodiment, commands (and their parameters) are parsed out and used to execute API calls in the windowing API of the platform on which the client is running. Commands and events are divided into logical segments for menu bars, windows, dialogs and resources for easy learning and reference. Many AGIL commands reference resources—definitions of GUI components to be instantiated.

As referred to herein, resources are groups of data used by an application, but remain separate from logic or control. Resources are used to describe or form the basis of visual components of an interface—these descriptions are usually referred to as metadata. Examples include strings of words to form menu items organized into lists and displayed as menus, window definitions and text rectangle definitions, radio buttons and check boxes that form dialog boxes, sound, and bitmap pictures.

Resources are created by a resource editor, a common programmer's productivity tool found in development tools. Resources provide several opportunities to improve a server application.

By defining and controlling application resources, server programmers can create highly organized and maintainable server applications, and refer to resources when creating a menu or dialog, without imbedding the details within the logic of the server application.

By storing resources centrally for delivery on demand and sending resources (menus and dialog boxes, for example) once for storage and use locally on the client, embodiments of the present invention significantly reduce network traffic.

Because resources are stored locally in embodiments of the present invention, response time is very fast. Each resource is identified and referenced by a unique identifier. This improves the response time of the GUI dramatically.

The GUI is more responsive because everything needed to display the GUI on the display is resident in the client application's local application memory and not shipped over the network and delivered to the client after the end user requests it to be displayed. Resources may be stored as simple textual data structures, using the tag model typified by HTML and XML, or on some platforms they may be compiled to conform to client requirements imposed by the platform. The server application may conduct a resource inventory and receive a table of resource data including name, resource ID, version, storage date and size. This way, resources can be updated transparently and universally without manual client updates at each client's workstation.

In another embodiment of the present invention, resources are compiled into binary form for runtime efficiency, and stored in a dynamically linked library (DLL). The DLL is moved independently of the application, reserving binding for run-time by caching the copy of the DLL sent by the server application on the client application for use during this session. At each new session, the server application has the opportunity to update the resource DLL automatically as described below.

A significant cost to IT departments is the distribution of software updates. In an embodiment of the present invention, to optimize the client/server application update process, the client application implements an automatic resource distribution mechanism to automate the transfer of resource files. Though an extended transfer may be announced to the end user, it is not a manual process.

Upon the instantiation of a given session, the server application may issue a Resource command. The client application responds by returning metadata about the current resource file, if the resource file exists. In certain instances, there may not be a locally stored resource DLL, as it may be the first time this particular client has ever logged on to this server. Alternatively, the server application may deliver the DLL for use during this session, and destroy it for security reasons. The resource file metadata includes a date and version number or other means of uniquely identifying the version. If the server application determines that one or more components of the resource file is obsolete, it may send a new resource file composed of the individual components required to replace the obsolete resources. The client application updates the resources, for later loading and instantiation of the contained resource templates, under the control of the server application.

The actual method of transferring the Resource DLL varies, depending on the embodiment of the present invention. FTP may be employed in some environments where security is not a concern (from a UNIX server behind a firewall, or over a virtual private network, for example). In other environments, WebDAV may be employed, especially over the Internet. In other environments, an internal (program to program) file transfer method may be required.

In addition to transferring the text resource file definition, the server application may send new or updated ActiveX Controls for local storage as well. FTP or other protocols may be employed for this purpose.

It is the prerogative of the server program system designer (for system simplicity) to use locally stored resources, updated as described above and ideal for infrequently changing user interfaces, or to supply the resource DLL every time at runtime and delete it at the end of each session, never caching it between sessions for increased security.

In an embodiment of the present invention, a server application is developed utilizing commands to instantiate and control the GUI as follows.

All of the resources used for the server application are designed and created using a GUI-based GUI design tool (for example, Visual Studio from Microsoft Corp.). Each specific dialog to be utilized in the application is designed and created and provided with a unique identifier. Each unique text string that is to be used for roll-overs, tool tips and other textual display in dialogs or other locations is created, also provided with a unique identifier. Menu bars are created in the same manner, and custom icons to be displayed in toolbars drawn as is common to a modern windowing environment.

Resources are compiled or otherwise collected as appropriate for the target client platform, as described below.

There are alternative methods of formatting resources for use by an application. In Windows, one method is to use the resource description file (RC file) from the GUI resource editor as input to the resource compiler for compilation to a DLL—all tools from Microsoft, and other competing companies. Alternatively, one could output XML files of resource descriptions from a GUI (or text) editor and compile them, or send the XML file directly to HighWire.

The functionality of the server application is designed and specified, and the source code of the server application produced to conform to the specifications. Commands from the AGIL command set (as one example of a command set used) are incorporated to instantiate and control each resource as required by the functional specifications. The program may be written in C/C++, Java, COBOL, Fortran, PERL, BASIC, assembly language or other language where the AGIL API is adapted for the chosen language.

The server application is compiled or otherwise prepared to execute properly on the target server platform. For example, if written in COBOL for CICS on MVS, the designer pre-processes for CICS, compiles, then links to produce the application. In Java for J2EE, the designer simply puts the code in a JAR file, which converts to byte code, and the application is ready for byte code interpretation as it executes in the JRE.

The collected resources are stored with the server program for distribution to the client application during runtime. The server platform may be a server-based mainframe (IBM, UNIX, Windows .NET, or other), and it may be a Web server as well (Apache, IIS, or other), though that is incidental. The server may be utilized on a client platform or it may actually run on the same platform as the client application. The Web server application may employ Web services including SOAP and WSDL as necessary.

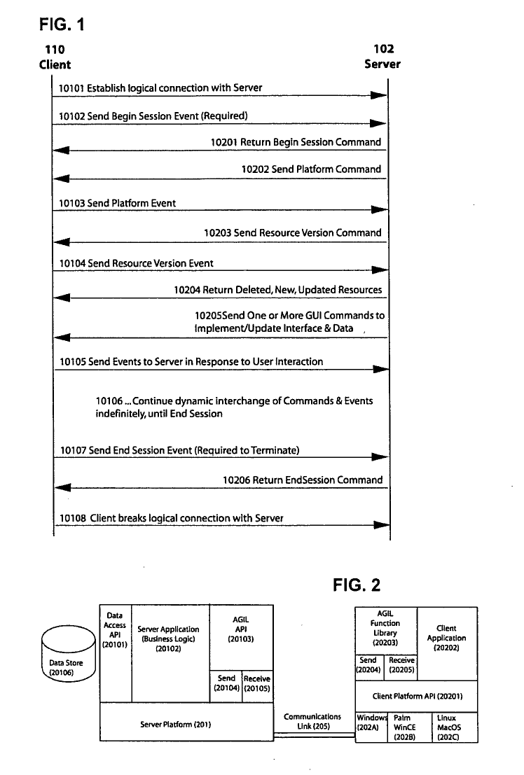

Referring to FIG. 1, there is shown a series of interactions between client application 101 and server application 102, where the two programs exchange commands and events. When the user selects server application 102 to log on to and clicks the Log on button, client application 101 establishes logical connection 10101 with server application 102, utilizing the chosen transport layer (such as http, TCP/IP, serial, etc.). Upon successful connection, appropriate authentication is performed (depending on the server application requirements). No other interaction occurs until a Begin Session command and event are exchanged, after which time specific functions may occur. Once client application 101 has connected, it sends Begin Session Event 10101 to advise server application 102 that it is prepared to interoperate per the prescribed procedural model. Server application 102 sends the Begin Session Command 10201 in response to the Begin Session Event 10102 to confirm that it to is ready to begin the session. This embodiment uses a Begin Session Command and event and an End Session and event exchange to denote and set a part a session. One skilled in the art may eliminate the Begin Session by, upon connection, operating in the state where the Begin Session would have been received. In other words, the Begin Session event is assumed or implied, rather than actually received.

In this context, if server application 102 is stateful, it may identify the new user and deduce a begin session. In a stateless environment (most CGI applications), Begin Session must be explicit. The End Session can likewise be assumed when one logs off, or quits the application. That is, when a user logs off or quits the client, server application 102 legitimately needs to know.

Server application 102 may send Platform Command 10202 to allow server application 102 to ascertain which commands and how much data to send at any one time, based on returned Platform Event 10103, and server application 102 may send a Resource Version Command 10203 to determine which deleted, updated and new resources must be sent to client application 101 based on Resource Version Event 10104. If client application 101 has obsolete resources (or no) resource file, the obsolete and new resources are transferred (reference numeral 10205) by a common file transfer method, plus a list of resources (if any) to delete. Server application 102 may (at the option of the designer) instruct client application 101 to store the resources on a local mass storage device for use in upcoming sessions. This optimizes resource management by storing them centrally and automatically distributing a current copy to store locally for instant use, without human intervention.

Next, client application 101 and server application 102 exchange commands and events dynamically 10506, depending on the design of server application 102 and the choices made by the end user during the session. At the end of the session an End Session Command 10104 and Event 10206 exchange occurs, and client application 101 terminates communication connection 10108. Actual termination of both client application 101 and server application 102 is completely independent of this method.

Referring now to FIG. 2, a block diagram illustrates the major functional components of both the client environment and the server environment. From a practical perspective, most server applications reside on a platform 201 that is separate from client platform 202A, 202B, or 202C for example, and connected via some communications link 205 over which a communication session is established. However, this is not a technical limitation. Server application 20102 may actually reside on the same platform as client application 20202. In such an embodiment, the user logs on (either explicitly or implicitly) via an internal TCP/IP socket connection providing inter-application communication via the operating system.

Additionally, in an embodiment, one or more clients connect to a multi-user server application 20102 on a server operating system (IBM VMS, MVS, or UNIX, for example). Alternatively, single client 20202 may connect to multiple server applications 20102 simultaneously and act as a system monitor. The Begin Session Command/Event functions in the API possess both a server and client unique identity, which may be implemented by server design so that the client can manage multiple server connections simultaneously.

Data access API 20101 and data store 20106 are typical components of an enterprise server application 20102, but are incidental to the disclosed embodiment, which has no direct bearing on data storage or access. It is shown here for clarity.

AGIL API 20103 is incorporated and utilized by server application 20102 to send commands via Send component 20104 to client application 20202 via its Receive component 20205, performing the data transmission via Server Platform 201 over communications link 205. Send component 20104 is called at the end of each AGIL Command call in AGIL API 20103 to perform the transmission of the command. Likewise, when an event is created in the client application 20202 by activities on the part of the end user, the event is formulated in the AGIL Function Library and delivered to the Send component 20204 for transmission to the server application 20102 via platform (202A, 202B, or 202C) via communications link 205. The event is received by the server application and delivered to the Receive component 20105 on the server for delivery to the Event callback function directly in the Server application 20102 via the general callback routine in the AGIL API 20103. Send and Receive components 20104, 20105 are specific to each platform 201 and serve to insulate the AGIL API from platform dependencies relating to data communications.

The request/response method of the present invention comprises the exchange of commands (messages from the server application), and events (messages from the client application). The dynamic sequence of commands, together with the actual resource templates in the resource implemented at run time, is the controlling factor in instantiating the actual interface realized by the end user. The server sends commands to implement GUI components and optionally to display data appropriate to a given component (text in a text window, a series of icons and names, organized hierarchically and available for display in a tree view window frame, or rows of recurring data elements each with different values in a grid or spreadsheet window, for example). These commands are sent based on the algorithms in the design of the server, and the state of the client, based on how the user interacts with the GUI component of the client.

As the user interacts with the client's displayed GUI components, event messages are returned to the server for processing and potential action. Events include user selection of a menu item, modification of the state of a check box, radio button, text or grid information, or clicking an OK, Cancel, or Apply button, for example. When appropriate, associated data is returned as well.

In an embodiment, to provide flexibility in distributing some or all of the GUI interface logic and improve system responsiveness by reducing network traffic where possible, the client application implements a method of locally storing and triggering commands that normally are transmitted from the host in response to an event, called the Local Execution Module (LEM). This module is called each time an event is generated, for the purpose of determining whether the event is to be acted upon in the client itself. After potential action, it may be sent on to the server program (by direction of the local action script).

The Resource file may contain key-pair values that form a Local Event Group. Each Local Event Group is composed of an event, plus one or more Commands that are to be executed upon generation of the event. Optionally, the Send To Server command may be included to transmit the Event as usual to the server for further action. Events and Commands may be stored as String types in a key-pair value in the resource file.

When the client application is launched, as part of its initialization routine, it reads the Local Event Group list (if present in the resource file) and loads it into an array, indexed by the Event. When the event is generated, it is passed to the Local Execution Module for processing. The LEM seeks a match between the event and an event-command group record in the array. If a match is found, the LEM obtains each command in the command group and serially sends it into the Command queue for processing, in the same manner as if it had been placed in the queue by the server application in the normal manner.

Menu Events rarely are conditional. That is, for each menu event, there is usually one set of commands to be executed, without the requirement for business logic. Therefore, the commands may be stored locally (rather than in the server application) and identified by the Event that generates them. A Find menu item selected by the user from the menu displays a Find dialog, for example. Therefore, the Display Dialog command may be stored locally for local execution, avoiding the round trip to the server.

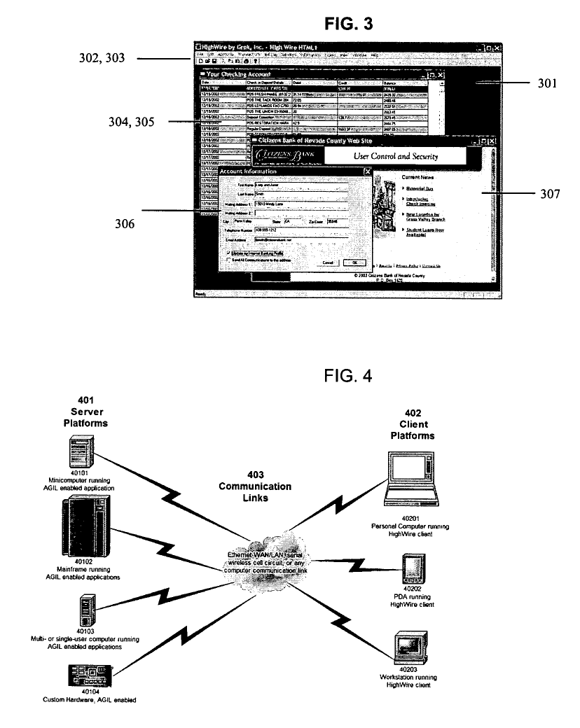

Referring now to FIG. 3, the resulting GUI displayed in client window 301 is controlled by the resources provided the client when the client/server session is initiated, and the commands sent by the server application to specify which resources to instantiate and display on the screen at any given moment. In this example, a specific menu resource is displayed, along with toolbar 302. Additionally, grid window 304 is displayed which supports spreadsheet and table style data edit and display, including sorting, column resizing and reordering, cut, copy and paste of cell selection(s), and local printing and copying. Each of these features is controlled by relevant Grid commands from the server. For example, if local printing is disallowed, the client will not print the contents of the window and the Print command is inactive. Not shown but included are windows for other major data types: discovery windows for hierarchically organized data, text windows, bitmap image display windows 305. Dialogs 306 are designed specifically for each structured record to display or provide a container for new records in a visual dialog editor. HTML page windows 307 provide Web server compatibility and facilitate html page display where appropriate. These major GUI components are illustrative of a comprehensive GUI; the list is not exhaustive, and the AGIL command set is extensible to add new windows as needed.

A self-contained online help system may also be employed. One method used is to name the CHM help system (in a Microsoft Windows environment) the same name as the server application. When the user clicks Help, the client application hands the named CHM file to the Microsoft Help DLL for execution. Other methods include creating text files and opening them directly via a menu item implemented for the purpose. The text file may be in a variety of formats: text, Word, RFT, PDF, depending on what is supported on the target client platform.

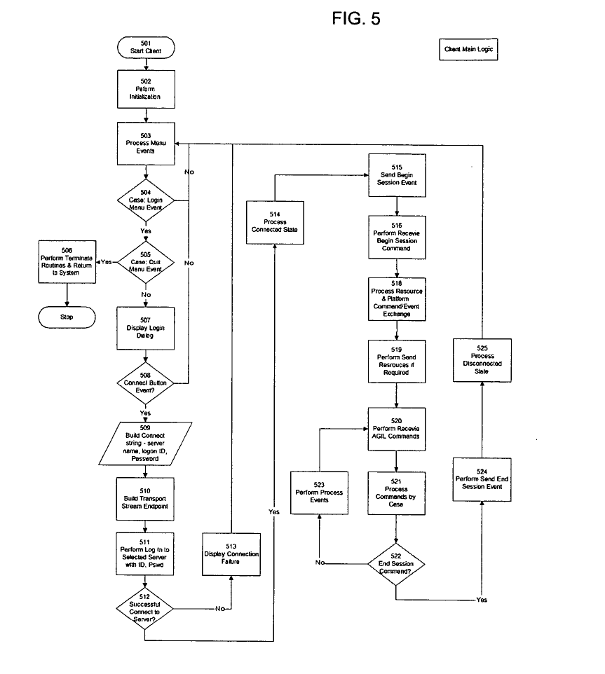

Typical Server and Client Platforms are illustrated in FIG. 4. Embodiments of the present invention (client application 402) may modified to run on a wide variety of computing devices, such as personal computer 40201, PDA 40202 or workstation 40203 that provides a GUI API and communications support 403. The AGIL protocol likewise may be utilized by any programming language, and the resulting server application may run on server 401, including minicomputers 40101, mainframes 40102, or other smaller computers and workstation 40103 of the same type as that the client runs on. The server application may also run on the very same platform as the client, in which case the communications link is a sockets connection via TCP/IP.

Imbedded hardware 40104 containing a basic computer and communications link (Ethernet port, or serial port for example) may also support a server application utilizing AGIL protocol. Examples include routers and switches, monitoring systems, and home controller systems, or key telephone systems or PBXs (private branch exchanges).

The main logic flowchart depicted in FIG. 5 generally describes the method employed to establish a session, perform resource and platform functions when a session begins, and process commands and events until the session ends. When the user launches the application (reference numeral 501), it performs initialization functions (reference numeral 502). When ready to interact with the end user, it displays the basic menu bar and processes menu events (reference numeral 503). The significant event relating to the embodiment is the Login menu event (reference numeral 504), which causes the client to display the Login dialog (reference numeral 507), allowing the user to manage server login details (add, edit and delete) and connect (reference numeral 508) to the selected server. Connecting to a server involves building the connect details (reference numeral 509), establishing a transport stream end point (reference numeral 510) and contacting the server over the established link (reference numeral 511). Upon successful login (reference numeral 512), the client enters the connected state (reference numeral 514) and processes commands until End Session command (reference numeral 522), at which point it returns to the disconnected state (reference numeral 524). During the connected state, the client must first send a Begin Session event (reference numeral 515) and obtain a positive reply. Next, the client may exchange Session and Platform commands and events (reference numeral 518) and receive new or updated resources and delete old ones as directed. Next, the client application enters a Receive AGIL Command loop (reference numeral 521), where it processes each command and acts upon it accordingly, and processes events (reference numeral 523) and sends them to the server until the End Session command (reference numeral 522) is received.

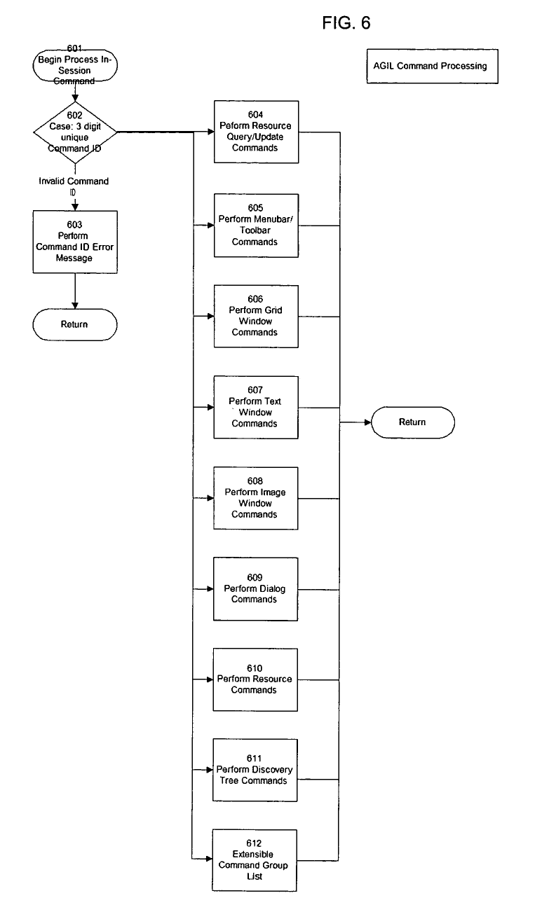

Referring to FIG. 6, the AGIL Command Process Logic diagram depicts in greater detail the method employed for identifying each AGIL Command and processing it to update the client's GUI. This component is a subroutine function called by Process Commands by Case (reference numeral 521 in FIG. 5) upon receipt of each command from the server. In this embodiment, each command has a three-digit identifier, although one skilled in the art could modify the number of digits and/or characters to meet unique identity or logical organizational requirements. Each command is uniquely identified by the smallest number of bytes possible to speed transmission). This Command ID integer is used to perform one of a series of routines in a case statement 602, depending on the Command ID. Error processing is handled in Command ID Error Message subroutine 603. Otherwise, subroutines 604 through 611 are called. This list is not exhaustive; the list is extensible as the technology advanced, but the method remains the same.

Some command IDs are reserved for server developer extensibility. A server programmer may for example implement a fully compiled application as a DLL for example, and identify commands with reserved IDs associated with the DLL. The client performs commands in the extensible command group list 612 as appropriate, and returns.

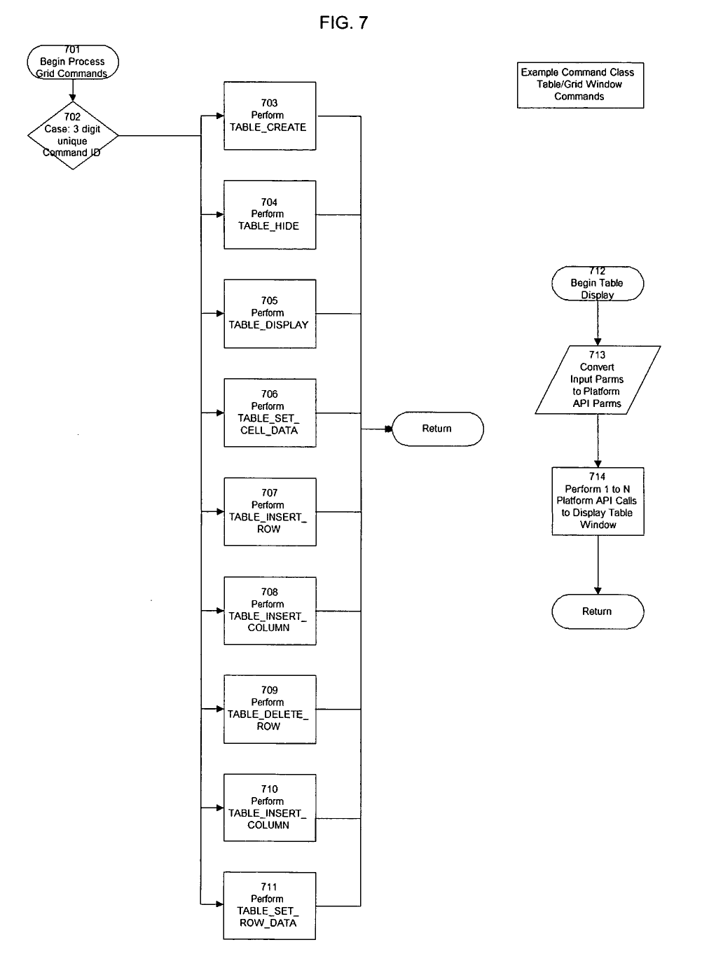

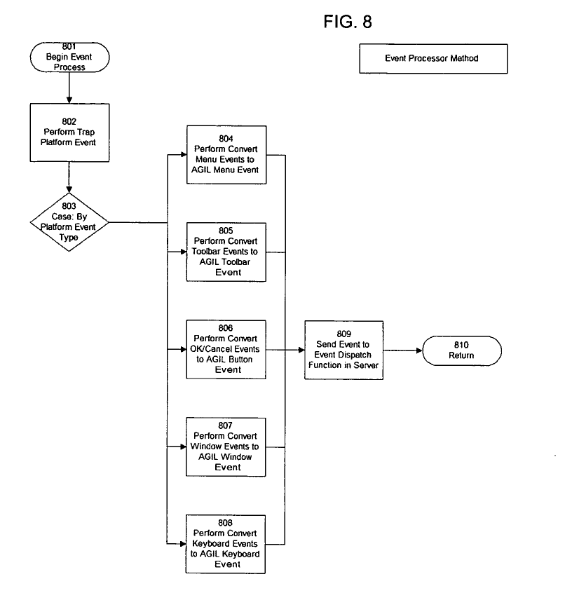

Directing attention to FIG. 7, there is described a typical method for implementing a common GUI component. The command ID has been identified as a Table command (referring now to FIG. 6, Perform Table Window Commands subroutine function 606), and Table Command subroutine function 701 is called with the same parameters passed down by calling subroutine 606. The command ID is cased for unique identity, and subroutine functions 703 through 711 may be executed. These commands are actual commands, but the list is not exhaustive; it is merely illustrative of the types of commands possible. See the AGIL Command API for the current list of commands.

At the most detailed level, the TABLE_DISPLAY command 705 is received, for example. The TABLE_DISPLAY subroutine function 712 is called, each input parameter received from the server is converted to the appropriate parameter to properly call and control the table as required into table functions that exist in the target DLL or platform, and the API Call(s) 714 are executed as appropriate to modify the table before returning.

Referring now to FIG. 8, as the user interacts with the user interface instantiated by the server via the client, certain events occur that materially affect the state of the server application. These events are trapped (reference numeral 802) and processed by the client. Each event is cased (reference numeral 803) to uniquely identify it as menu event 804, toolbar event 805, OK and Cancel button events in dialogs 806 (or other control item events if the server has determined it should be made aware), window events 807, and certain keyboard events (return keys, function keys, etc.) 808. Again this list is comprehensive but not exhaustive. It describes the method of identifying material client application system events and converting them to high level AGIL events for sending to the Event Dispatcher 809 in the server, where they are subsequently sent to a specific subroutine function for their server-side execution (as shown in the sample server code below).

The sample source code is included as an example of the basic framework and logic for implementing a server application that implements the API and is able to send Commands to the client and receive Events from the client. It is included for instruction, and may be extended or modified by a computer programmer in any manner to implement a specific server application, based on the application designer's software requirements and design requirements. Versions of this Sample Server Application may be written in other languages as well.

The sample server application changes over time to accommodate unintended errors, server design improvements, and AGIL protocol and client application changes and improvements.

AGIL API in C—This include file is included to disclose exemplary Commands.

The actual API include file can change over time to accommodate unintended errors, client application design improvements, and AGIL protocol and client application changes and improvements. Versions of this API may be provided in other languages as well.

Source Code of Sample Server Application /*********************************************************** *****
Sample Online Bank GUI Server Application
Copyright (c) 2003, Grok, Inc.
Version 3.2 03/22/03 Larry Wood and Jon Richards
This program is designed to run on a server as a
CGI program initiated
by an http server. This simple application shows the typical
interaction with the Client application using the AGIL protocol.
This program makes use of a library of AGIL helper functions that
encode and decode to and from the AGIL protocol. The programmer
does require any knowledge of how the AGIL protocol functions. The
programmer uses the AGIL functions listed in agillib.h.
This program serves as a sample skeleton code example of
a typical structure for a server program controlling the client.
*************************************************************** ********/
#include <stdio.h>
#include <stdlib.h>
#include <string.h>
#include <math.h>
#include <time.h>
#include “/usr/local/include/mysql/mysql.h”
/* Include any AGIL specific functions or variables. */
#include “../include/AGILE_Utils.h”
#include “../include/agillib.h”
/* Include any client specific functions or variables
#include “../include/HighWire.h”
/* Include the resource file defining the constants used in the */
/* User Interface components.*/
#include “resource.h”
/*************************************************************** *
   main( )
   This is the main function of the program.
   Functional steps:
   1) Get CGI input.
   2) Dispatch events to appropriate event handlers.
   3) Send commands back to the client.
   4) Return (exit).
*************************************************************** */
int
main (int argc, char **argv)
{
/* Get the input data, in the form of CGI arguments, which include */
/* the AGIL commands informing this program of user events that */
/* have taken place in the client. */
AGILE_Utils_GetInputData(data);
/* Initialize the AGIL library for HTTP. */
AGILInit(AG_HTTP);
/* Calla dispatch function that routs the events in the client*/
/* to the appropriate event handler function below. */
if (AGILDispatchEvent (data))
{
   /* Send the data to the client. */
   AGILSendCommands( );
   return (0);
}
/* Exit the program. */
return (0);
}
/*************************************************************** *
   AGILSessionEvent( )
   This handles the following events:
   BEGIN_SESSION_REQ
   END_SESSION_REQ
   Functional steps:
   1) If event is BEGIN_SESSION_REQ then send start up AGIL commands.
   2) If event is END_SESSION_REQ then send an end session to the client.
   4) Return (exit).
*************************************************************** */
void
AGILSessionEvent (char *Event)
{
FILE *fpBankData;
int RowID;
char szBankRecord[512];
int nEvent;
nEvent=atol (Event); //convert 3 digit char str to integer for caseing switch (nEvent)
case NBEGIN_SESSION_REQ:
/* Inform the client the session can begin. */
AGILBeginSession ( );
/* Inform client of any User Interface resource DLLs it needs to load. */
AGILLoadResource (“SMALLTEST.DLL”, AG_RES_{—}0);
/* Tell the client-Create a menu bar fm resource file and display */
AGILMenuCreate (AG_RES_{—}0, IDR_MENU1);
AGILMenuDisplay(AG_RES_{—}0, IDR_MENU1);
   /* Tell the client to Create a Window for displaying text. */
      1. AGILWindowCreate(TEXT_WINDOW,“Text-o-Rama”,10,10,200,350);
   /* Tell the client to create a text element to fill the window. */
   AGILTEXTCreate(TEXT_WINDOW);
   /* Tell the client to Define the Font to use. */
   AGILTEXTFont(TEXT_WINDOW,“Arial”);
/* Tell the client to Create a dialog. */
   1. AGILDialogCreate (AG_RES_{—}0, IDD_DIALOG1, IDD_DIALOG1, AG_MODAL, AG_CONTROLEVENT,1,2,NULL);
   /* Tell the client to Put data in the dialog. */
   AGILDialogSetControlValue (IDD_DIALOG1,IDC_LIST3,
      1. “Apples˜Pears˜Carrots˜Oranges˜Sandwiched˜piza˜Worm Salad˜cat hairs˜choclate”,0);
   /* Tell the client to Display the dialog. */
   AGILDialogDisplay(IDD_DIALOG1);
break;
case NEND_SESSION_REQ:
/* Just send an end session command. */
AGILEndSession ( );
break;
default:
break;
}
}
/*************************************************************** *
   AGILMenuEvent( )
   This handles the following events:
   Any menu bar item selected.
   Functional steps:
   1) Determine which menu item has been selected.
2) Send a command to the client to perform some action.
************************************************************ ****/
void
AGILMenuEvent (int nRsc_ID, int nMenu_ID, int nItem_ID)
{
char string[256];
switch (nItem_ID)
{
case ID_SHOWTEXT:
/* Show the text window if it is hidden or minimized. */
AGILWindowShow(TEXT_WINDOW);
break;
case ID_HIDETEXT:
/* Hide the text window. */
AGILWindowHide(TEXT_WINDOW);
break;
case ID_TEXT1:
/* Replace all the text in the text window with this test string. */
AGILTextSetText(TEXT_WINDOW, “This is the first line of text.\n”);
break;
case ID_TEXT2:
/* Append these text strings to the text window. */
AGILTextAddText(TEXT_WINDOW, “This is the next Line1\n”);
AGILTextAddText(TEXT_WINDOW, “This is the next Line2\n”);
break;
case ID_REMOVE:
/* Delete this menu item from the menu bar. */
AGILMenuDelete(AG_RES_{—}0,2);/* Remove the third one. */
break;
case ID_DISABLE_{—}1:
/* Disable this menu item. */
AGILMenuItemDisable(AG_RES_{—}0, ID_TEXT1);
break;
case ID_ENABLE_{—}1:
/* Enable this menu item. */
AGILMenuItemEnable(AG_RES_{—}0, ID_TEXT1);
break;
}
}
/************************************************************ ****
AGILDialogEvent( )
*
This handles the following events:
Any dialog GUI item changed or selected
Functional steps:
1) Determine which dialog GUI item has been selected.
2) Send a command to the client to perform some action.
************************************************************ ****/
void
AGILDialogEvent (int dialog_inst,int dialog_item,void *data)
{
switch (dialog_item)
{
case IDCANCEL: // user clicked cancel or close box
/* Hide the dialog, do not destroy it. */
AGILDialogHide (IDD_DIALOG1);
break;
case IDOK:
/* Hide the dialog, do not destroy it. */
AGILDialogHide (IDD_DIALOG1);
break;
default:
break;
} // switch
} // END OF DialogEvent Callback
/************************************************************ ****
AGILTableEvent( )
This handles the following events:
Any table item changed or selected.
Functional steps:
1) Determine which table item has been selected.
2) Send a command to the client to perform some action.
************************************************************ ****/
void
AGILTableEvent (char *Event)
{
} // end AGILTableEvent Callback
/************************************************************ ****
AGILToolbarEvent( )
This handles the following events:
Any tool bar item selected.
Functional steps:
1) Determine which tool bar item has been selected.
2) Send a command to the client to perform some action.
************************************************************ ****/
void
AGILToolbarEvent (char *Event)
{
} // end AGILToolbarEvent
/************************************************************ ****
AGILToolbarEvent( )
This handles the following events:
Any window event such as resize or cancel.
Functional steps:
1) Determine which event has taken place.
2) Send a command to the clienbt to perform some action
void
AGILWindowEvent(int window_inst,int wind_item)
{
if(wind_item==IDCANCEL)
/* Display a message box that the window has closed. */
AGILDisplayMessageAlert (“WINDOW CLOSED!”);
}
} // END OF AGILWindowEvent
Public AGIL API in C
//*****************************************************
//
// AGILE_HTTP.h—Public Routines
// Prototypes for HTTP API functions for the client
// Authors: Jon Richards, Larry Wood
// Copyright 2003 Grok, Inc.
// Version 1.1—Mar. 20, 2003
//
//*****************************************************
#include <stdio.h>
#include <stdlib.h>
#define BOOL unsigned char
#define AG_WIN_{—}0 0
#define AG_WIN_{—}1 1
#define AG_WIN_{—}2 2
#define AG_WIN_{—}3 3
#define AG_WIN_{—}4 4
#define AG_WIN_{—}5 5
#define AG_WIN_{—}6 6
#define AG_WIN_{—}7 7
#define AG_WIN_{—}8 8
#define AG_WIN_{—}9 9
#define AG_WIN_{—}10 10
#define AG_RES_{—}0 0
#define AG_RES_{—}1 1
#define AG_RES_{—}2 2
#define AG_RES_{—}3 3
#define AG_RES_{—}4 4
#define AG_RES_{—}5 5
#define AG_DIALOG_{—}0 0
#define AG_DIALOG_{—}1 1
#define AG_DIALOG_{—}2 2
#define AG_DIALOG_{—}3 3
#define AG_DIALOG_{—}4 4
#define AG_DIALOG_{—}5 5
#define AG_DIALOG_{—}6 6
#define AG_DIALOG_{—}7 7
#define AG_DIALOG_{—}8 8
#define AG_DIALOG_{—}9 0
#define AG_DIALOG_{—}10 10
#define AG_NO_ERROR 1
#define AG_HTTP 1
#define AG_SERIAL 2
#define AG_MODAL 0
#define AG_MODELESS 1
#define AG_AUTOEVENT 0
#define AG_ALLCONTROLEVENT 1
#define AG_CONTROLEVENT 2
typedef struct_AG_key value
{
long nKey;
char *szValue;
}AG_key_value;
int AGILBeginHTMLDoc( );
int AGILSendCommands( );
int AGILBeginSession( );
int AGILEndSession( );
int AGILDispatchEvent(char *data);
int AGILMenuCreate(int nRscID, int nMenuID);
int AGILMenuDisplay(int nRscID, int nMenuID);
int AGILMenuDelete (int nRscID, int nMenuID);
int AGILToolbarCreate(int nRscID, int nToolbarID);
int AGILToolbarDisplay(int nRscID, int nToolbarID);
int AGILLoadResource(char* szRscName, int nRscInst);
int AGILDialogCreate(int nRscID, int nDlogID,
int nDlogInst,int nMode, int nEvent, . . . );
int AGILDialogSetControlValueKeyValues(int nDlogInst,AG_key_value *key_value, . . . );
int AGILDialogSetControlValue( int nDlogInst, . . . );
int AGILDialogDisplay(int nDlogInst);
int AGILDialogDestroy(int nDlogInst);
int AGILDialogRecord(int nDlogInst, char * szDlogRecord);
int AGILDialogHide(int nDlogInst);
int AGILListElements(int nDlogID, int nCtlID, char* szElementList);
int AGILBeep_Speaker( );
int AGILDisplayNoteAlert( );
int AGILDisplayCautionAlert( );
int AGILDisplayStopAlert( );
int AGILDisplayMessageAlert(char* szMsgString);
int AGILTableCreate(int nWinNum, int nHeadRow,
int nHeadCol, int nRow, int nCol,
BOOL bVisible, char* szGridTitle);
int AGILTableDisplay(int nRscInst);
int AGILTableHide(int nRscInst);
int AGILTableSetCellData(int nRscInst, int nRowID, int nColID, char* szCellStr);
int AGILTableInsertRow(int nRscInst, int nRowID);
int AGILTablelnsertColumn(int nRscInst, int nColID);
int AGILTableDeleteRow(int nRscInst, int nRowID);
int AGILTableDeleteColumn(int nRscInst, int nColID);
int AGILTEXTCreate(int nWinNum);
int AGILTextDisplay(int nWinNum);
int AGILTextHide(int nWinNum);
int AGILTextSetText(int nWinNum, char* szText);
int AGILTextAddText(int nWinNum, char *szText);
int AGILSelectMenuItem(int nRscID, int nMenuID, int nMenuItemID);
int AGILSelectDlogButton(int nDlogInst, int nBtnID);
int AGILCloseWindow(int nWindInst);
int AGILOutput(const char *fmt, . . . );
int AGILInitSerialPort(int baud,char parity, int databits, int stopbits);
int AGILWindowCreate(int nWinNum,char *szTitle,
int nX,int nY, int nWidth,int nHeight);
int AGILWindowDestroy(int nWinNum);
int AGILWindowMinimize(int nWinNum);
int AGILWindowMaximize(int nWinNum);
int AGILWindowShow(int nWinNum);
int AGILWindowHide(int nWinNum);
int AGILWindowSize(int nWinNum,int nX,int nY, int nWidth,int nHeight);
int AGILHTMLCreate(int nWinNum);
int AGILHTMLLoadURL(int nWinNum,char *szURL);
int AGILMenuItemDisable(int nRscID, int nMenuItem);
int AGILMenuItemEnable(int nRscID, int nMenuItem);
int AGILTEXTFont(int nWinNum,char *szFontName);

What is claimed is:

1. In a client-server environment, a method of providing a graphical user interface (GUI) to an end-user, the method comprising:
a client application receiving commands from a server application, the commands dictating a GUI implementation to be displayed to an end-user, the GUI implementation revealed to the client application only at run time; and
the client application returning events to the server application, the events indicating state change in the client application.

2. The method of claim 1, wherein the server application and client application communicate with each other without being bound through linking.

3. The method of claim 1, further comprising:
the client application displaying to the end-user a list of server applications with logon details;
the client application accepting from the end-user a selection from the list; and
the client application presenting a minimal set of interface elements to allow the end-user to communicate with the server application.

4. The method of claim 1, wherein the client application connects to a default server application.

5. The method of claim 1, further comprising:
the client application receiving resources from the server application, the received resources having been separately compiled into binary form and stored in a dynamic linked library for runtime efficiency, the dynamic linked library moved independently of the client application; and
the client application reserving binding for runtime by caching the dynamic linked library.

6. The method of claim 1, further comprising:
the client application receiving resources from the server application, the received resources being defined using human readable textual descriptions, the resources moved independently of the client application;
the client application reserving binding for runtime by caching the resources;
and
the client application processing the resources into runtime form.

7. The method of claim 1, wherein the client application is based on a protocol that eliminates a requirement for HTML as a method of presenting the GUI to the end-user.

8. The method of claim 1, wherein the GUI implementation is displayed and utilized based on a protocol, the protocol eliminating a requirement for producing any custom logic in the client application.

9. The method of claim 1, wherein the client application communicates with the server application using a protocol, the protocol reducing the number of API calls made between the client application and server application.

10. The method of claim 1, further comprising the client application allowing the end-user to manipulate the list of server applications.

11. The method of claim 1, wherein the server application executes on a different platform than the client application.

12. The method of claim 1, wherein the server application executes on the same platform as the client application.

13. The method of claim 1, wherein the client application can connect simultaneously to a plurality of server applications.

14. A computer-readable medium containing instructions which, when executed by a computer, provide a graphical user interface (GUI) to an end-user, by:
directing a client application to receive commands from a server application, the commands dictating a GUI implementation to be displayed to an end-user, the GUI implementation revealed to the client application only at run time; and
directing the client application to return events to the server application, the events indicating state change in the client application.

15. The method of claim 1, further comprising instructions for directing the client application to communicate with the server application without being bound to the server application through linking.

16. The computer-readable medium of claim 14, further comprising instructions for:
directing the client application to display to the end-user a list of server applications with logon details;
directing the client application to accept from the end-user a selection from the list; and
directing the client application to present a minimal set of interface elements to allow the end-user to communicate with the server application.

17. The computer-readable medium of claim 14, further comprising instructions that direct the client application to connect to a default server application.

18. The computer-readable medium of claim 14, further comprising instructions that for:
directing the client application to receiv resources from the server application, the received resources having been separately compiled into binary form and stored in a dynamic linked library for runtime efficiency, the dynamic linked library moved independently of the client application; and
directing the client application to reserve binding for runtime by caching the dynamic linked library.

19. The computer-readable medium of claim 14, further comprising instructions for:
directing the client application to receive resources from the server application, the received resources being defined using human readable textual descriptions, the resources moved independently of the client application;
directing the client application to reserve binding for runtime by caching the resources;
and
directing the client application to process the resources into runtime form.

20. The computer-readable medium of claim 14, further comprising instructions for directing the client application to comply with a protocol that eliminates a requirement for HTML as a method of presenting the GUI to the end-user.

21. The computer-readable medium of claim 14, further comprising instructions for directing the GUI implementation to be displayed and utilized based on a protocol, the protocol eliminating a requirement for producing any custom logic in the client application.

22. The computer-readable medium of claim 14, further comprising instructions for directing the client application to communicate with the server application using a protocol, the protocol reducing the number of API calls made between the client application and server application.

23. The computer-readable medium of claim 14, further comprising instructions for directing the client application to allow the end-user to manipulate a list of server applications.

24. The computer-readable medium of claim 14, further comprising instructions for directing the client application to execute on a different platform than the server application.

25. The computer-readable medium of claim 14, further comprising instructions for directing the client application to execute on the same platform as the server application.

26. The computer-readable medium of claim 14, further comprising instructions for directing the client application to connect simultaneously to a plurality of server applications.

27. A client application for use in a client-server environment, the client application comprising:
means for receiving commands from a server application, the commands dictating a GUI implementation to be displayed to an end-user, the GUI implementation revealed to the client application only at run time; and
means for returning events to the server application, the events indicating state change in the client application.

28. The client application of claim 27, further comprising means for the server application and client application to communicate with each other without being bound through linking.

29. The client application of claim 27, further comprising:
means for displaying to the end-user a list of server applications with logon details;
means for accepting from the end-user a selection from the list; and
means for presenting a minimal set of interface elements to allow the end-user to communicate with the server application.

30. The client application of claim 27, further comprising means for connecting to a default server application.

31. The client application of claim 27, further comprising:
means for receiving resources from the server application, the received resources having been separately compiled into binary form and stored in a dynamic linked library for runtime efficiency, the dynamic linked library moved independently of the client application; and
means for reserving binding for runtime by caching the dynamic linked library.

32. The client application of claim 27, further comprising:
means for receiving resources from the server application, the received resources being defined using human readable textual descriptions, the resources moved independently of the client application;
means for reserving binding for runtime by caching the resources;
and
means for processing the resources into runtime form.

33. The client application of claim 27, wherein the client application is based on a protocol that eliminates a requirement for HTML as a method of presenting the GUI to the end-user.

34. The client application of claim 27, wherein the GUI implementation is displayed and utilized based on a protocol, the protocol eliminating a requirement for producing any custom logic in the client application.

35. The client application of claim 27, wherein the client application communicates with the server application using a protocol, the protocol reducing the number of API calls made between the client application and server application.

36. The client application of claim 27, further comprising means for allowing the end-user to manipulate the list of server applications.

37. The client application of claim 27, wherein the server application executes on a different platform than the client application.

38. The client application of claim 27, wherein the server application executes on the same platform as the client application.

39. The client application of claim 27, further comprising means for connecting simultaneously to a plurality of server applications.
